(19) United States
(12) Patent Application Publication
(10) Pub. No.: US 2026/0323664 A1
(43) Pub. Date: Oct. 15, 2026

(54) METHOD AND APPARATUS FOR OPERATING BASED ON PHYSICAL SIDELINK FEEDBACK CHANNEL (PSFCH) OCCASION IN SIDELINK COMMUNICATION

(71) Applicant: Intellectual Discovery Co., Ltd., Seoul (KR)

(72) Inventor: Hyuk Min SON, Seoul (KR)

(21) Appl. No.: 19/466,891

(22) Filed: Feb. 2, 2026

Related U.S. Application Data
(63) Continuation of application No. PCT/KR2024/010811, filed on Jul. 25, 2024.

(30) Foreign Application Priority Data
Aug. 4, 2023 (KR) 10-2023-0102105
Jul. 23, 2024 (KR) 10-2024-0096980

(51) Int. Cl. H04W 72/25; H04W 74/08

(52) U.S. Cl. CPC H04W 72/25; H04W 74/0866

(57) ABSTRACT

Sidelink communication methods and apparatus are described. According to one embodiment, a method of a terminal for performing sidelink communication comprises configuring at least one physical sidelink feedback channel (PSFCH) occasion and performing transmission of a PSFCH based on the configured at least one PSFCH occasion, wherein the at least one PSFCH occasion is configured per resource pool (RP), and wherein the transmission of the PSFCH is performed within a channel occupancy time (COT).

### CROSS-REFERENCE TO RELATED APPLICATIONS

This application is a continuation of PCT Application No. PCT/KR2024/010811, filed on Jul. 25, 2024, which claims priority from Korean Patent Application No. 10-2023-0102105, filed on Aug. 4, 2023, and Korean Patent Application No. 10-2024-0096980, filed on Jul. 23, 2024, which are also incorporated herein by reference in their entirety.

### BACKGROUND OF THE DISCLOSURE

### Technical Field

The present disclosure relates to 3GPP 5G sidelink communication.

### Background Art

As an increasing number of communication devices demand greater communication traffic over time, a next-generation 5G system, which is an enhanced wireless broadband communication system compared to the conventional LTE system, is required. In this next-generation 5G system, also referred to as NewRAT, communication scenarios are classified into Enhanced Mobile Broadband (eMBB), Ultra-Reliability and Low-Latency Communication (URLLC), Massive Machine-Type Communications (mMTC), and so on.

Here, eMBB is a next-generation mobile communication scenario that has characteristics such as High Spectrum Efficiency, High User Experienced Data Rate, and High Peak Data Rate. URLLC is a next-generation mobile communication scenario characterized by features such as Ultra Reliability, Ultra Low Latency, and Ultra High Availability (e.g., V2X, Emergency Service, Remote Control). mMTC is a next-generation mobile communication scenario characterized by features such as Low Cost, Low Energy, Short Packet, and Massive Connectivity (e.g., IoT).

### SUMMARY OF THE DISCLOSURE

The present disclosure is to provide a method and an apparatus for operating based on a physical sidelink feedback channel (PSFCH) occasion in sidelink communication.

An embodiment of the present specification provides a method in which, in sidelink (SL) communication, a terminal configures at least one physical sidelink feedback channel (PSFCH) occasion and performs transmission of the PSFCH based on the configured at least one PSFCH occasion, wherein the at least one PSFCH occasion is configured per resource pool (RP), and the transmission of the PSFCH is performed within a channel occupancy time (COT).

Further, an embodiment of the present specification provides a terminal for sidelink (SL) communication, comprising a control unit, and a memory unit storing instructions and being operably and electrically connectable to the control unit, wherein operations performed based on the instructions being executed by the control unit comprise: configuring at least one physical sidelink feedback channel (PSFCH) occasion, and performing transmission of the PSFCH based on the configured at least one PSFCH occasion, wherein the at least one PSFCH occasion is configured per resource pool (RP), and the transmission of the PSFCH is performed within a channel occupancy time (COT).

Meanwhile, the at least one PSFCH occasion is allocated to at least one slot. Here, the at least one slot comprises a plurality of slots, and the transmission of the PSFCH is performed via one of the plurality of slots.

Furthermore, PSFCH transmission attempts are sequentially performed for the plurality of slots, and prior to the one slot in which the transmission of the PSFCH is performed, there exists at least one slot in which a transmission attempt of the PSFCH has failed.

The period of the at least one PSFCH occasion is 1 slot, 2 slots, or 4 slots.

Channel occupancy sharing information is received from another terminal, and the transmission of the PSFCH is performed using it.

According to the disclosure of the present specification, the operation of a PSFCH for sidelink communication can be efficiently performed.

### BRIEF DESCRIPTION OF THE DRAWINGS

FIG. 1 is a diagram illustrating a New Radio (NR) wireless communication system.

FIG. 2 illustrates a structure of a radio frame used in the NR.

FIG. 3 illustrates a slot structure of an NR frame.

FIG. 4 illustrates an example of a Next Generation Radio Access Network (NG-RAN) architecture that supports a PC5 interface.

FIGS. 5A to 5B illustrate procedures for performing sidelink communication according to a sidelink resource allocation mode.

FIGS. 6A to 6C are diagrams illustrating a first method for configuring a PSFCH occasion within a COT according to the disclosure of the present specification.

FIGS. 7A to 7D are diagrams illustrating a second method for configuring a PSFCH occasion within a COT according to the disclosure of the present specification.

FIGS. 8A to 8B are diagrams illustrating a third method for configuring a PSFCH occasion within a COT according to the disclosure of the present specification.

FIG. 9 illustrates an operation method of a terminal according to an embodiment of the present specification.

FIG. 10 illustrates an operation method of a terminal according to another embodiment of the present specification.

FIG. 11 illustrates a wireless communication apparatus according to an embodiment of the present specification.

### DETAILED DESCRIPTION OF THE DISCLOSURE

Although embodiments are described herein using an LTE system, an LTE-A system, and an NR system, these embodiments may be applied to any communication system corresponding to the above definitions.

Furthermore, in the present specification, the term ‘base station’ may be used as a comprehensive term that includes a remote radio head (RRH), an eNB, a transmission point (TP), a reception point (RP), a relay, and the like.

3GPP-based communication standards define downlink physical channels corresponding to resource elements that carry information originating from a higher layer, and downlink physical signals corresponding to resource elements that are used by the physical layer but do not carry information originating from a higher layer. For example, the physical downlink shared channel (PDSCH), physical broadcast channel (PBCH), physical multicast channel (PMCH), physical control format indicator channel (PCFICH), physical downlink control channel (PDCCH), and physical hybrid ARQ indicator channel (PHICH) are defined as downlink physical channels, and a reference signal and a synchronization signal are defined as downlink physical signals. A reference signal (RS), also referred to as a pilot, means a predefined special waveform signal known to both a gNB and a UE. For example, cell-specific RS, UE-specific RS (UE-RS), positioning RS (PRS), and channel state information RS (CSI-RS) are defined as downlink reference signals. 3GPP LTE/LTE-A standards define uplink physical channels corresponding to resource elements that carry information originating from a higher layer, and uplink physical signals corresponding to resource elements that are used by the physical layer but do not carry information originating from a higher layer. For example, the physical uplink shared channel (PUSCH), physical uplink control channel (PUCCH), and physical random access channel (PRACH) are defined as uplink physical channels, and a demodulation reference signal (DMRS) for uplink control/data signals and a sounding reference signal (SRS) used for uplink channel measurement are defined.

In this specification, Physical Downlink Control Channel (PDCCH)/Physical Control Format Indicator Channel (PCFICH)/Physical Hybrid automatic retransmit request Indicator Channel (PHICH)/Physical Downlink Shared Channel (PDSCH) respectively mean a set of time-frequency resources or a set of resource elements carrying Downlink Control Information (DCI)/Control Format Indicator (CFI)/downlink ACKnowledgement/Negative ACK (ACK/NACK)/downlink data. Furthermore, Physical Uplink Control Channel (PUCCH)/Physical Uplink Shared Channel (PUSCH)/Physical Random Access Channel (PRACH) respectively mean a set of time-frequency resources or a set of resource elements carrying Uplink Control Information (UCI)/uplink data/random access signals.

Meanwhile, an NR frequency band may be defined with two types of frequency ranges (FR1 and FR2). The numerical values of the frequency ranges may be changed. For example, the two types of frequency ranges (FR1 and FR2) may be as shown in Table 1 below. For convenience of description, among the frequency ranges used in the NR system, FR1 may mean a “sub 6 GHz range”, and FR2 may mean an “above 6 GHz range” and may be called a millimeter wave (mmW).

TABLE 1

| Frequency Range | Corresponding | Subcarrier |
|---|---|---|
| designation | frequency range | Spacing |
| FR1 | 410 MHz-7125 MHz | 15, 30, 60 kHz |
| FR2 | 24250 MHz-52600 MHz | 60, 120, 240 kHz |

The numerical values of the frequency range of the NR system may be changed. For example, FR1 may include a band from 410 MHz to 7125 MHz as in Table 1. That is, FR1 may include a frequency band of 6 GHz (or 5850, 5900, 5925 MHz, etc.) or higher. For example, the frequency band of 6 GHz (or 5850, 5900, 5925 MHz, etc.) or higher included in FR1 may include an unlicensed band. The unlicensed band may be used for various purposes, for example, for communication for vehicles (e.g., autonomous driving).

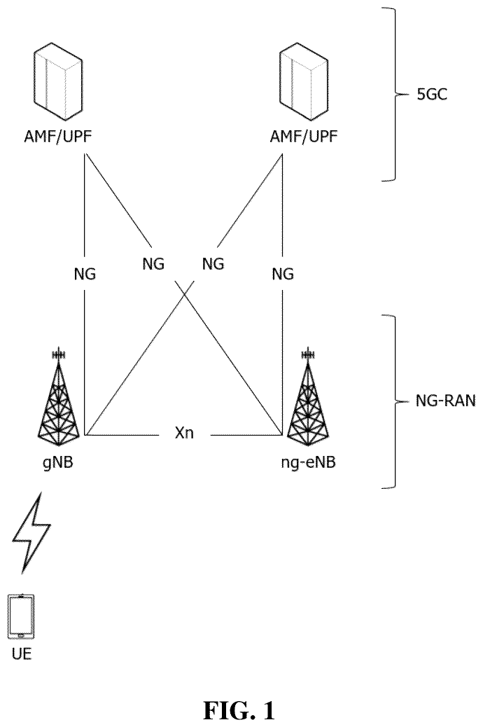

FIG. 1 is a diagram illustrating an NR wireless communication system.

Referring to FIG. 1, the NR wireless communication system may be classified into a 5G core network (5GC) and a next generation-radio access network (NG-RAN), and the NG-RAN may include base stations (gNB and/or ng-eNB) that provide user plane and control plane protocol termination to a user equipment (UE). A gNB (next generation-Node B) provides NR user plane and control plane protocol termination to the UE, and an ng-eNB (next generation-evolved Node B) provides evolved-universal terrestrial radio access (E-UTRA) user plane and control plane protocol termination to the UE. The user equipment (UE) may be fixed or have mobility, and may be called by other terms such as mobile station (MS), user terminal (UT), subscriber station (SS), mobile terminal (MT), or wireless device. The base station (gNB and/or ng-eNB) may be a fixed station that communicates with the UE, and may be called by other terms such as base transceiver system (BTS), access point, etc.

The base stations (gNB and/or ng-eNB) may be connected to each other via an Xn interface, and may be connected to a 5G core network (5GC) via an NG interface. Specifically, the base stations (gNB and/or ng-eNB) may be connected to an access and mobility management function (AMF) via an NG-C interface, and may be connected to a user plane function (UPF) via an NG-U interface.

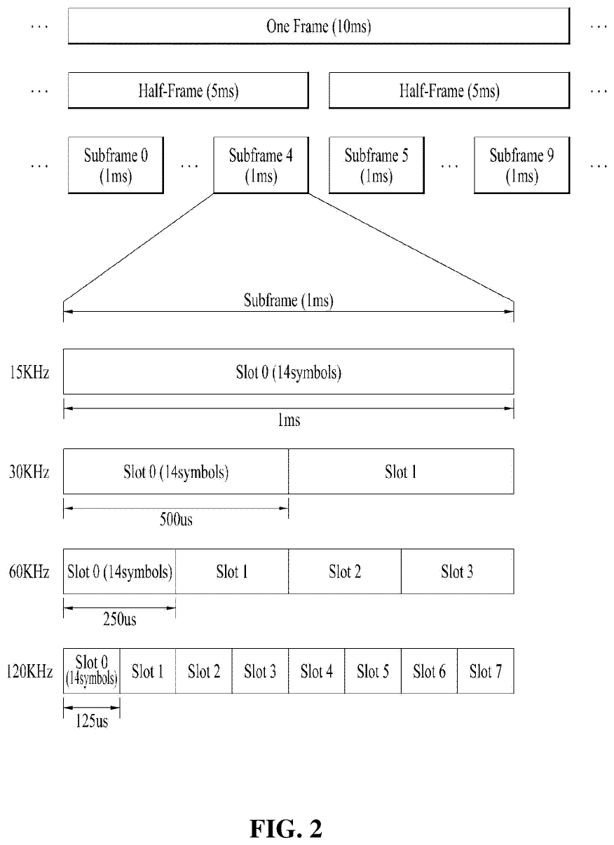

FIG. 2 illustrates a structure of a radio frame used in NR.

In NR, uplink and downlink transmissions are composed of frames. A radio frame has a length of 10 ms and is defined by two 5 ms Half-Frames (HFs). A half-frame is defined by five 1 ms subframes (SFs). A subframe is divided into one or more slots, and the number of slots within a subframe depends on the subcarrier spacing (SCS). Each slot includes 12 or 14 OFDM (A) symbols depending on the cyclic prefix (CP). In the case of normal CP, each slot includes 14 symbols. In the case of extended CP, each slot includes 12 symbols. Here, a symbol may include an OFDM symbol (or CP-OFDM symbol) or an SC-FDMA symbol (or DFT-s-OFDM symbol).

Table 2 illustrates that when normal CP is used, the number of symbols per slot, the number of slots per frame, and the number of slots per subframe vary depending on the SCS.

TABLE 2

| SCS(15*2^{u}) | N^{slot}_{symb} | N^{frame, u}ₛₗₒₜ | N^{subframe, u}ₛₗₒₜ |
|---|---|---|---|
| 15 KHz(u = 0) | 14 | 10 | 1 |
| 30 KHz(u = 1) | 14 | 20 | 2 |
| 60 KHz(u = 2) | 14 | 40 | 4 |
| 120 KHz(u = 3) | 14 | 80 | 8 |
| 240 KHz(u = 4) | 14 | 160 | 16 |

N^{slot}_{symb}: number of symbols in a slot
N^{frame, u}ₛₗₒₜ: number of slots in a frame
N^{subframe, u}ₛₗₒₜ: number of slots in a subframe

Table 3 illustrates that when extended CP is used, the number of symbols per slot, the number of slots per frame, and the number of slots per subframe vary depending on the SCS.

TABLE 3

| SCS (15*2^{u}) | N^{slot}_{symb} | N^{frame, μ}ₛₗₒₜ | N^{subframe, μ}ₛₗₒₜ |
|---|---|---|---|
| 60 KHz (u = 2) | 12 | 40 | 4 |

In an NR system, OFDM (A) numerology (e.g., SCS, CP length, etc.) may be set differently among a plurality of cells that are aggregated for a single UE. Accordingly, the (absolute time) duration of a time resource (e.g., SF, slot, or TTI) composed of the same number of symbols (collectively referred to as a Time Unit (TU) for convenience) may be set differently among the aggregated cells.

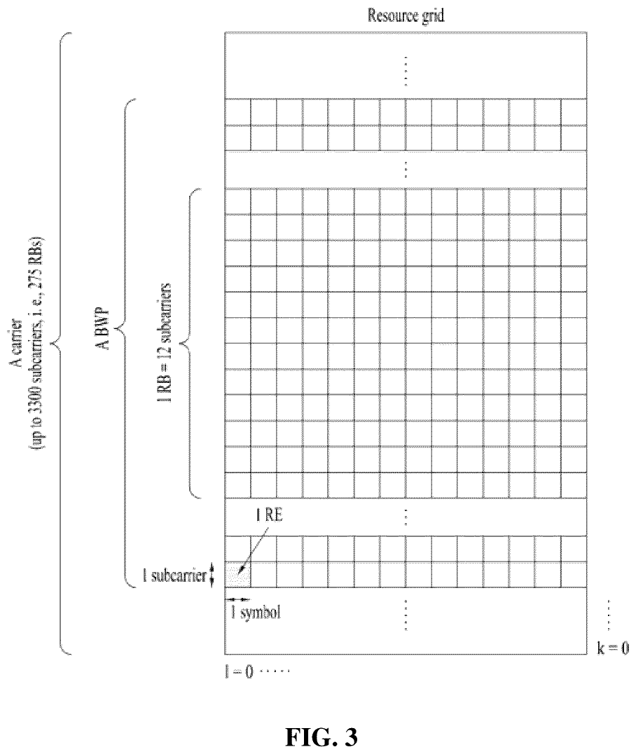

FIG. 3 illustrates a slot structure of an NR frame.

A slot includes a plurality of symbols in the time domain. For example, in the case of normal CP, one slot includes 14 symbols, but in the case of extended CP, one slot includes 12 symbols. A carrier includes a plurality of subcarriers in the frequency domain. A resource block (RB) is defined by a plurality of (e.g., 12) consecutive subcarriers in the frequency domain. A bandwidth part (BWP) is defined by a plurality of consecutive (P) RBs in the frequency domain, and may correspond to one numerology (e.g., SCS, CP length, etc.). A carrier may include up to N (e.g., 4) BWPs. Data communication is performed through an activated BWP, and only one BWP may be activated for one UE. Each element in a resource grid is referred to as a Resource Element (RE), and one complex symbol may be mapped to it.

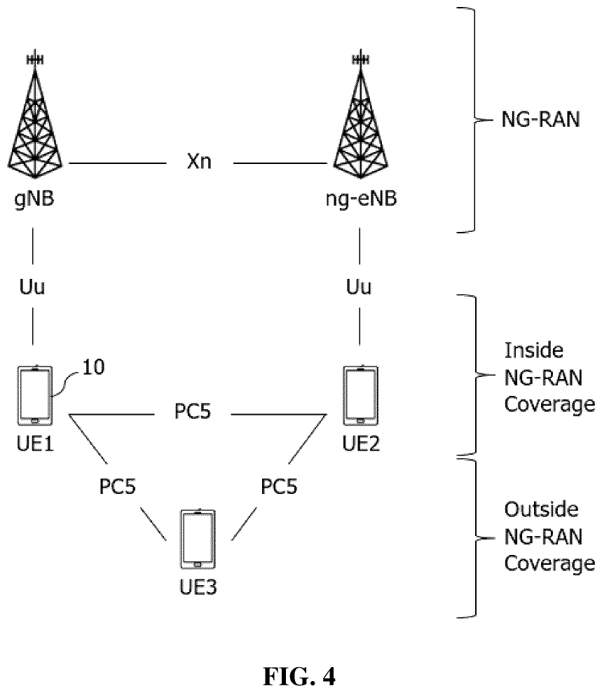

FIG. 4 illustrates an example of an NG-RAN architecture that supports a PC5 interface.

Referring to FIG. 4, the next generation-radio access network (NG-RAN) architecture supports the PC5 interface. Sidelink transmission and reception via the PC5 interface are supported both when the user equipment (UE) is inside NG-RAN coverage and when the UE is outside NG-RAN coverage, regardless of the radio resource control (RRC) state of the UE.

Vehicle-to-Everything (V2X) service support via the PC5 interface may be provided by NR sidelink communication and/or V2X sidelink communication. NR sidelink communication may also be used to support services other than V2X services.

NR sidelink communication may support one type among a unicast transmission mode, a groupcast transmission mode, and a broadcast transmission mode. In the case of unicast type sidelink communication, a UE may perform one-to-one communication with another UE. In the case of groupcast type sidelink communication, a UE may perform sidelink communication with one or more UEs within a group to which it belongs.

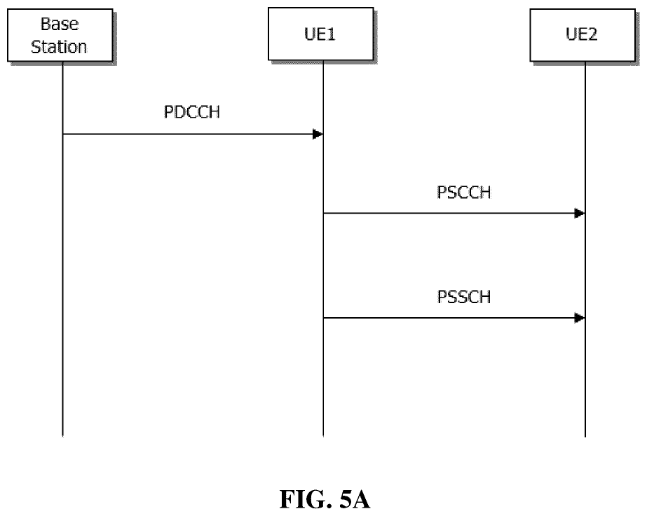

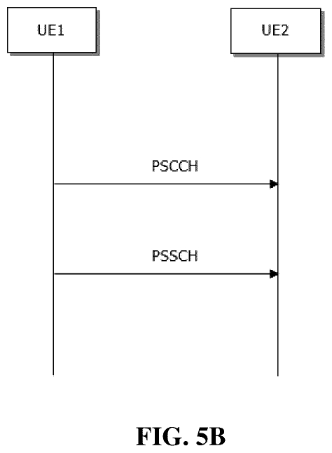

FIGS. 5A to 5B illustrate procedures for performing sidelink communication according to a sidelink resource allocation mode.

FIG. 5A illustrates a UE operation related to NR resource allocation mode 1, and FIG. 5B illustrates a UE operation related to NR resource allocation mode 2.

Referring to FIG. 5A, in NR resource allocation mode 1, a base station may schedule sidelink (SL) resources to be used by a user equipment (UE) for SL transmission. For example, the base station may perform resource scheduling for UE1 using a downlink control channel (DCI) transmitted via a physical downlink control channel (PDCCH), and UE1 may perform V2X or SL communication with UE2 according to the resource scheduling. For example, UE1 may transmit sidelink control information (SCI) to UE2 via the physical sidelink control channel (PSCCH), and then transmit SL data to UE2 via the physical sidelink shared channel (PSSCH) based on the SCI.

Referring to FIG. 5B, in NR resource allocation mode 2, a user equipment (UE) may determine a sidelink (SL) transmission resource within an SL resource configured by a base station or a pre-configured SL resource. For example, the configured SL resource or pre-configured SL resource may be a sidelink resource pool. For example, the UE may autonomously select or schedule a resource for SL transmission. That is, a UE may perform SL communication by autonomously selecting a resource within a configured resource pool. Furthermore, the UE may perform a sensing and resource (re) selection procedure to autonomously select a resource within a selection window. For example, the sensing may be performed on a sub-channel basis. As shown in FIG. 5B, UE1, which has autonomously selected a resource within the resource pool, may transmit SCI to UE2 via the PSCCH, and then transmit data based on the SCI to UE2 via the PSSCH.

Discussions are ongoing regarding PSFCH occasion and PSFCH transmission methods via channel access in Sidelink-Unlicensed (SL-U), and development of related PSFCH transmission and operation methods is needed. Therefore, the present specification proposes methods related to the above description.

First Disclosure: Methods for Configuring a PSFCH Occasion within a COT

According to NR sidelink (SL) standards, PSFCH (transmission) occasions for each resource pool (RP) are configured and operated with a period of 1, 2, or 4 slots, and it is possible to configure an RP without PSFCH occasions. Therefore, the configuration of PSFCH occasions in SL-U may be applied by using the content of the disclosures of the following methods.

### First Method

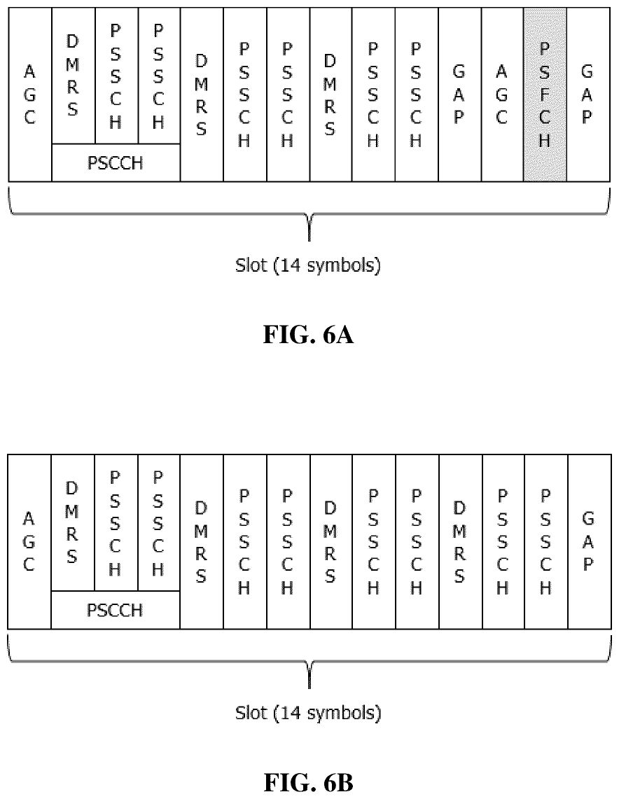

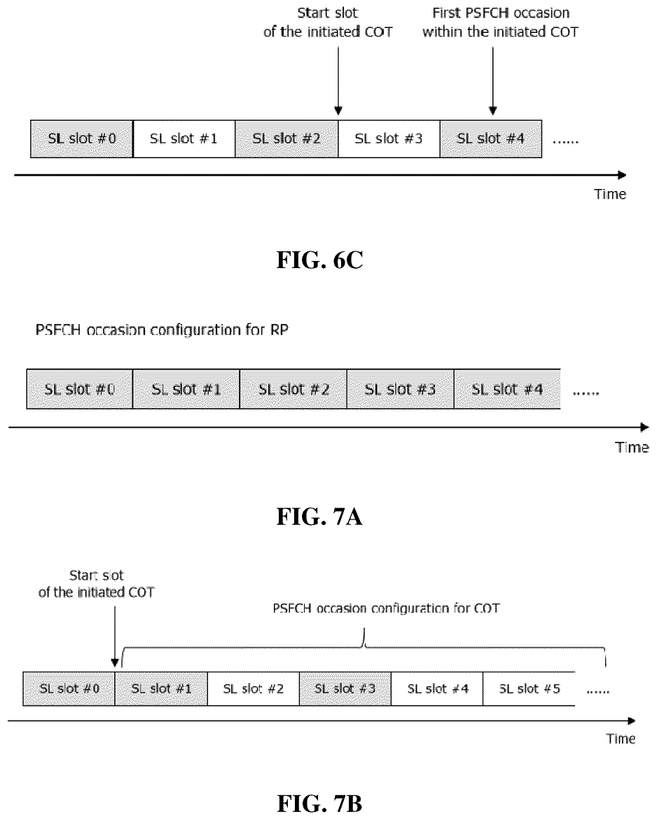

FIGS. 6A to 6C are diagrams illustrating a first method for configuring a PSFCH occasion within a COT according to the disclosure of the present specification.

The PSFCH configuration value set for each RP is applied as is within the COT interval. In this case, the configuration of a PSFCH occasion within an initiated COT in SL-U will have a PSFCH occasion in a slot with a period of 1, 2, or 4 slots as configured in the RP.

FIG. 6A is an example of an SL slot format with a PSFCH occasion where a PSCCH is allocated 3 symbols, FIG. 6B is an example of an SL slot format without a PSFCH occasion where a PSCCH is allocated 3 symbols, and FIG. 6C is an example of slot allocation with a PSFCH occasion when the PSFCH occasion is configured with a 2-slot period in the RP. A slot where a PSFCH occasion like that in FIG. 6A may be sent may be allocated with a 2-slot period, such as Slot #0, #2, #4. In the remaining slots, such as Slot #1, #3, an SL slot like that in FIG. 6B without a PSFCH occasion may be allocated. FIG. 6C shows a case in which a specific UE succeeds in COT initiation through a channel access attempt, and the COT starts from SL slot #3. In this case, the first occasion on which a PSFCH may actually be transmitted is from SL slot #4, according to the PSFCH occasion configured in the RP. That is, the first PSFCH occasion starts from SL slot #4.

### Second Method

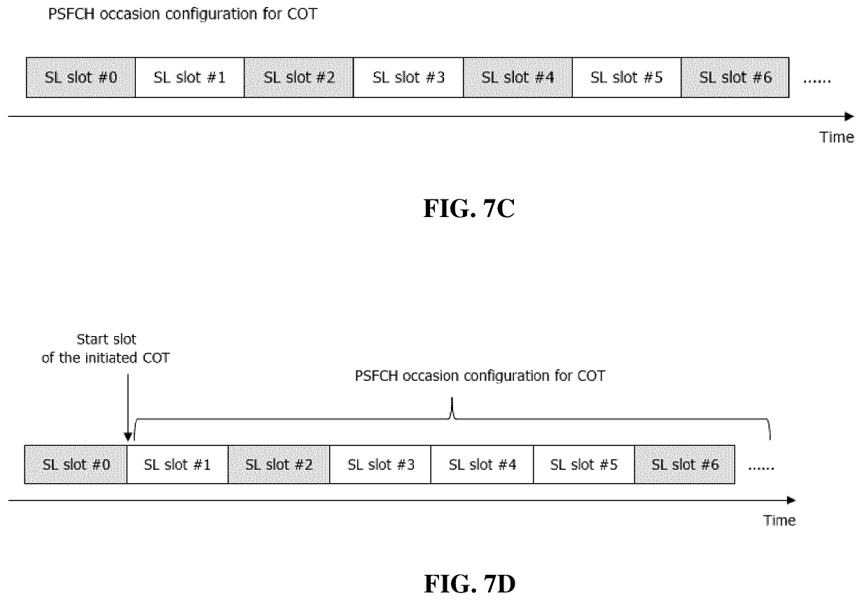

FIGS. 7A to 7D are diagrams illustrating a second method for configuring a PSFCH occasion within a COT according to the disclosure of the present specification.

Based on the per-RP configured PSFCH occasion settings, the configuration of PSFCH occasions used within a COT may be performed via COT sharing information (COT-SI). In this case, the configuration of additional PSFCH occasions within the COT, other than the per-RP configured PSFCH occasions, may be prevented. That is, among the per-RP configured PSFCH occasions, the PSFCH occasions to be used within the COT may be reconfigured and operated via COT-SI.

If PSFCH occasions are reconfigured via COT-SI, the COT-SI includes period information for the PSFCH occasions within the COT, and PSFCH operation may be performed based on this.

FIG. 7A shows a case where the PSFCH occasion configuration in the RP is set to a 1-slot period. That is, there is a PSFCH occasion in every slot. In this case, if the COT-SI indicates a 2-slot period for the PSFCH occasion configuration within the COT, the available PSFCH occasions within the COT may be reconfigured as shown in FIG. 7B, such as SL slot #1, SL slot #3, and SL slot #5.

Furthermore, FIG. 7C shows a case where the PSFCH occasion configuration in the RP is set to a 2-slot period. That is, there is one PSFCH occasion every 2 slots. In this case, if the COT-SI indicates a 2-slot period again for the PSFCH occasion configuration within the COT, only one slot every 2 slots within the pre-configured PSFCH occasions may be configured and operated as a PSFCH occasion within the COT. That is, if the PSFCH occasions based on the RP-configured PSFCH occasions were allocated in the form of previous PSFCH occasion slot index +2, such as SL slot #2, SL slot #4, SL slot #6, etc., then within the COT, as shown in FIG. 7d, they may be allocated in the form of previous PSFCH occasion slot index +4, such as SL slot #2, SL slot #6, etc.

In the example of the above method, it was described in a form that includes additional period information used within the COT-SI based on the slot period information for the PSFCH occasions configured in the RP, but the period to be used within the COT may be directly included and operated.

For example, in the case of FIGS. 7A and 7B, the PSFCH occasion slot period information in the COT-SI may be set to 2 and operated. And, in the case of FIGS. 7C and 7D, the PSFCH occasion slot period information may be set to 4 and operated.

In this case, the start time of a PSFCH occasion may be indicated via COT-SI according to the time at which the COT starts. For example, in FIG. 7D, although the PSFCH occasion slot period is 4, the PSFCH occasion within the COT should start at SL slot #2 to operate within the RP-configured PSFCH occasions. In this case, the slot position setting where the PSFCH occasion starts within the COT may be additionally indicated via COT-SI. The position of the corresponding slot may be relative position information within the COT.

Alternatively, to allow the terminal to know the start position of a PSFCH occasion within the COT based on the per-RP configured PSFCH occasion slot period information, the position information of the slot where the COT starts may be indicated via COT-SI. The position of the corresponding slot may be relative position information within the COT.

Unlike the aforementioned methods, PSFCH occasions available within a COT may be allocated via COT-SI in the form of a bitmap. The COT-SI may indicate a bitmap for PSFCH occasions to be used within the COT, based on all SL slots of the COT. For example, in the example of FIGS. 7A and 7B, assuming that the COT is from SL slot #1 to SL slot #5, the bitmap may be indicated in the form of “10101”.

In the example of FIGS. 7C and 7D, assuming that the COT is from SL slot #1 to SL slot #6, the bitmap may be indicated in the form of “010001”.

Alternatively, to reduce the size of the bitmap, the bitmap may be configured based on the PSFCH occasion slots configured in the RP. In the example of FIGS. 7C and 7D, assuming that the COT is from SL slot #1 to SL slot #6, since only SL slot #2 and #6 are configured and used within the COT based on the RP-configured SL slots #2, #4, #6, the bitmap may be indicated in the form of “101”. In this case, as proposed above, the start time of a PSFCH occasion may be indicated via COT-SI according to the time at which the COT starts. Alternatively, the position information of the slot where the COT starts may be indicated via COT-SI.

### Third Method

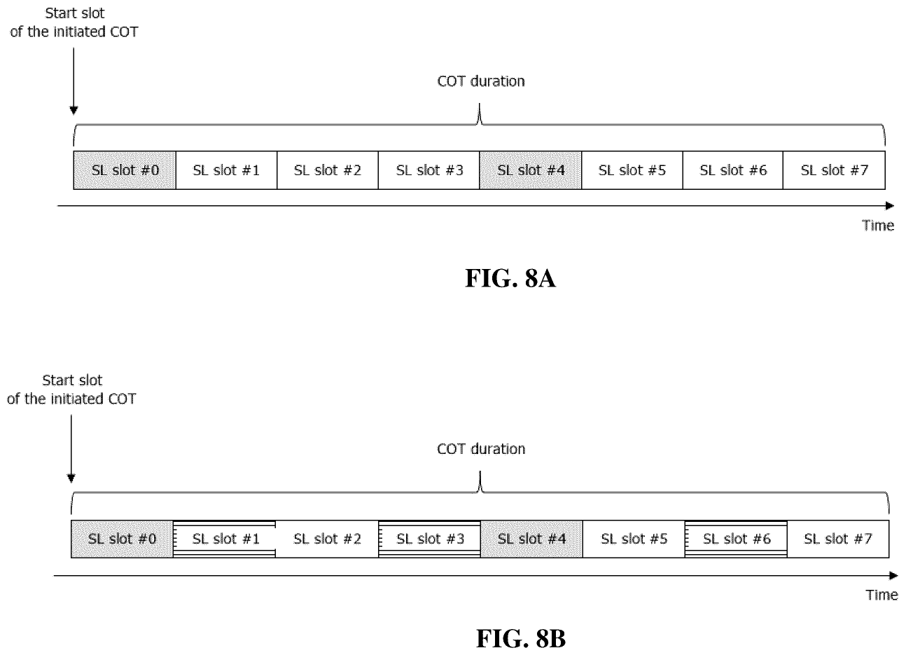

FIGS. 8A to 8B are diagrams illustrating a third method for configuring a PSFCH occasion within a COT according to the disclosure of the present specification.

Based on the per-RP configured PSFCH occasion settings, the configuration of additional PSFCH occasions to be used within a COT may be performed via COT sharing information (COT-SI). That is, in addition to the per-RP configured PSFCH occasions, additional PSFCH occasions to be used within the COT may be reconfigured and operated via COT-SI.

To additionally configure PSFCH occasions within a COT via COT-SI, an additional PSFCH occasion slot period may be indicated. Alternatively, an additional PSFCH slot period may be configured through an indication in the form of a bitmap.

If an additional PSFCH occasion slot period is indicated in COT-SI, by setting a period value lower than the PSFCH slot period configured in the existing RP, per-RP configured PSFCH occasions and additional PSFCH occasions can be configured within the COT. For example, if the per-RP PSFCH occasion slot period is configured as 4, and the PSFCH occasion slot period is indicated as 2 via COT-SI, a PSFCH occasion is configured every 2 slots within the corresponding COT, enabling the configuration of PSFCH occasions including the per-RP configured PSFCH occasions.

If an additional PSFCH occasion slot period is indicated in COT-SI, the corresponding period may be configured based on the remaining slots, excluding the per-RP configured PSFCH occasions, within the COT. FIG. 8A is an example where the configuration is applied as is within the COT interval in a case where the per-RP configured PSFCH occasion slot period is set to 4. When an additional PSFCH occasion slot period of 2 is indicated via COT-SI, additional PSFCH occasion allocation is possible as shown in FIG. 8B. It is an example where, based on FIG. 8A, a PSFCH occasion slot period of 2 is applied to the slots without PSFCH occasions, which are SL slot #1, #2, #3, #5, #6, #7, to additionally allocate PSFCH occasions to SL slot #1, #3, #6.

In FIGS. 8A and 8B, the start position of a PSFCH occasion is fixed to the first slot of the COT, but it may be configured and operated to indicate the start position of the PSFCH occasion via COT-SI and change that position. In this case, to indicate the start position of the PSFCH occasion in the COT-SI, an indication of the COT start position or a direct indication of the start slot position within the COT may be made. In this case, the position of the corresponding slot may be relative position information within the COT.

Unlike the indication method using a period value, an indication method in the form of a bitmap may be used to additionally configure PSFCH occasions within a COT via COT-SI. If a bitmap is configured based on all slots of the COT, it may be indicated in the form of ‘11011010’ based on FIG. 8B. To reduce the size of the bitmap, the bitmap may be configured based on the remaining slots other than the per-RP configured PSFCH occasions. In this case, based on FIG. 8A, a 6-bit size bitmap may be configured based on the slots without per-RP configured PSFCH occasions within the COT, which are SL slot #1, SL slot #2, SL slot #3, SL slot #5, SL slot #6, and SL slot #7. Since the additionally used slots in FIG. 8b are SL slot #1, #3, #6, the bitmap may be configured as ‘101010’.

### Fourth Method

PSFCH occasions may be configured and operated by COT-SI, regardless of the RP configuration. For this, the PSFCH occasion slot period may be configured based on all slots within the COT via COT-SI. Alternatively, a bitmap may be configured and indicated for the PSFCH occasion slot configuration within the COT.

In the above method, the PSFCH occasion in the COT-SI may be indicated based on or in conjunction with configuration information values such as the per-RP configured PSFCH occasion slot period. That is, the indication method(s) in COT-SI that were proposed in the second method or the third method described above may be applied, and furthermore, they may be applied in a simple, modified, combined, and/or extended form of these method(s).

In the case of the fourth method, it may be operated to be used for COT internal PSFCH occasion configuration only when there is no per-RP PSFCH occasion configuration.

The contents of the first to fourth methods for configuring PSFCH occasions within a COT may be operated in a simple, modified, combined, and/or extended form.

In the third method and the fourth method, for a PSFCH occasion additionally configured within the COT, other than the per-RP configured PSFCH occasions, channel access may be limited to a COT initiating UE, a responding UE, or a UE that has received COT-SI information. This may be utilized as a method for configuring and operating a COT-specific PSFCH occasion. Here, the COT initiating UE is the UE that initiated the corresponding COT, and the responding UE is the target UE of the COT initiating UE, i.e., the UE to which the COT initiating UE intends to transmit data/signals.

Therefore, for a PSFCH occasion configured to be COT-specific within a COT, if neither the COT initiating UE nor the responding UE transmits a PSFCH on a specific PSFCH occasion, the COT initiating UE or the responding UE does not have to transmit a signal such as a PSFCH like signal or a PSSCH on the corresponding occasion to prevent an arbitrary user from accessing that resource region or to prevent a COT interruption. However, for a PSFCH occasion within a COT configured by an RP, if neither the COT initiating UE nor the responding UE transmits a PSFCH on a specific PSFCH occasion, the COT initiating UE or the responding UE may transmit a PSSCH or a PSFCH like signal on that occasion to prevent COT interruption.

Second Disclosure: a Method for Operating N PSFCH Occasions Associated with One PSCCH/PSSCH

N PSFCHs associated with one PSCCH/PSSCH may be configured within a COT. In this case, the value of N may be configured to be RP-specific or COT-specific. For the configuration, one or a combination of radio resource control (RRC), medium access control-control element (MAC-CE), and sidelink control information (SCI) may be used. If configured to be COT-specific, it may be indicated in the COT-SI. The COT-SI may be configured by one or a combination of RRC, MAC-CE, and SCI, and at least SCI may be included for the COT-SI configuration.

The number of PSFCH transmission attempts for one PSCCH/PSSCH within a COT or in an interval including and after the COT may be set and operated with a maximum of N times. For example, in an environment where N PSFCH occasions are associated with a single PSCCH/PSSCH, if an LBT failure occurs on the nearest PSFCH occasion, PSFCH transmission may be attempted by sequentially performing LBT on the configured PSFCH occasions.

In the above operation, if a HARQ feedback RTT (Round Trip Time) restriction is configured, i.e., if an ACK/NACK for a single PSCCH/PSSCH is set to be fed back within a specific time, the maximum number of times a PSFCH may be transmitted may be subject to a restriction. For convenience of explanation, let's assume the specific time duration by which the HARQ feedback must arrive, based on the time point when one PSCCH/PSSCH was transmitted, is T. That is, PSFCH transmission may not be attempted on a PSFCH occasion that exceeds the time point T among the N PSFCH occasions. Therefore, in SL-U, the maximum number of PSFCH transmission attempts corresponding to one PSCCH/PSSCH may be determined as a value equal to or less than N, depending on the time point when the PSCCH/PSSCH was transmitted, the value of N, and the value of T.

Third Disclosure: a Method for Operating a PSFCH Occasion within a COT

The operation for a method of allowing PSFCH transmission to a UE other than the COT initiating UE using a PSFCH occasion configured within a COT may be performed in the following manner.

The responding UE may operate by including, via COT-SI, indication information on whether to allow PSFCH transmission to a UE other than the COT initiating UE within the corresponding COT. For example, it may be indicated via a 1-bit field in the COT-SI. In this case, if PSFCH transmission is allowed according to the indication, the responding UE may perform PSFCH transmission to a UE other than the COT initiating UE. Conversely, if not allowed, the responding UE may attempt PSFCH transmission to another UE via a per-RP configured PSFCH occasion in a resource interval that is not the COT resource region.

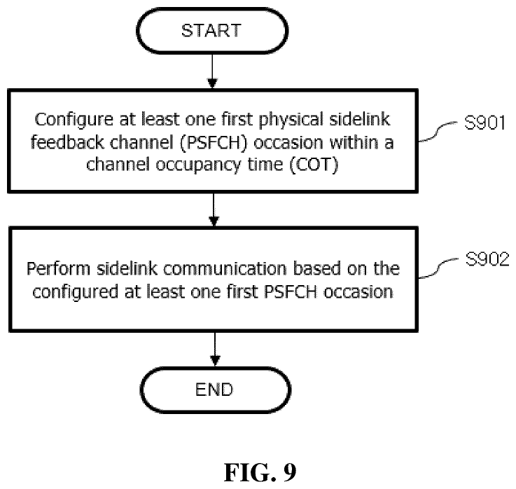

FIG. 9 illustrates an operation method of a terminal according to an embodiment of the present specification.

Referring to FIG. 9, a terminal configures at least one first physical sidelink feedback channel (PSFCH) occasion within a channel occupancy time (COT) (S901). Thereafter, the terminal performs sidelink communication based on the configured at least one first PSFCH occasion (S902).

The period of the configured at least one first PSFCH occasion may be 1 slot, 2 slots, or 4 slots.

The period of the at least one first PSFCH occasion may be configured per resource pool (RP).

COT sharing information (COT-SI) may be used for reconfiguring the period of the at least one first PSFCH occasion.

Meanwhile, at least one second PSFCH occasion may be configured in addition to the at least one first PSFCH occasion. And, COT sharing information (COT-SI) may be used for configuring the period of the at least one second PSFCH occasion.

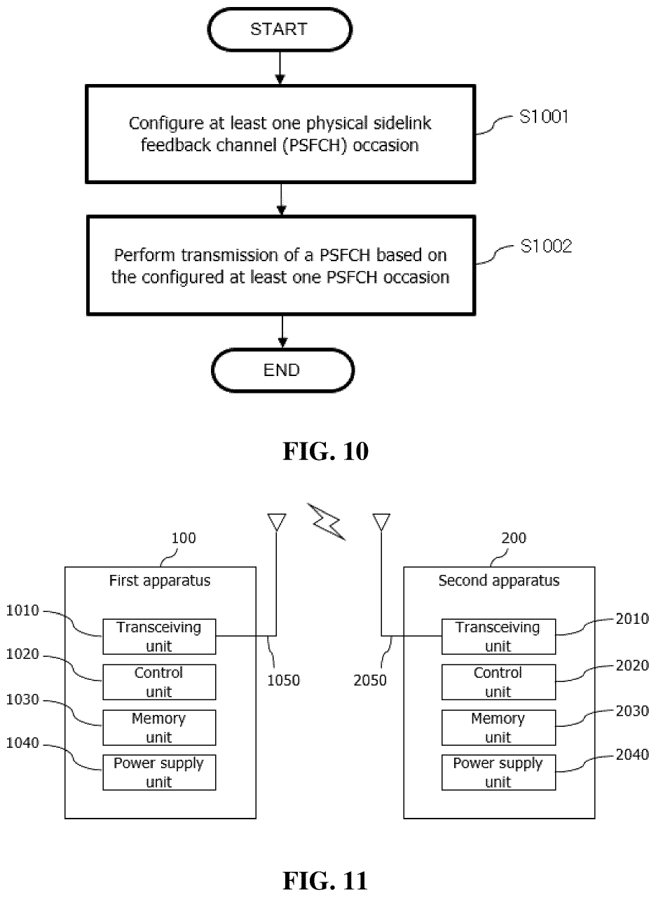

FIG. 10 illustrates an operation method of a terminal according to another embodiment of the present specification.

Referring to FIG. 10, a terminal configures at least one physical sidelink feedback channel (PSFCH) occasion (S1001). Thereafter, the terminal performs transmission of the PSFCH based on the configured at least one PSFCH occasion (S1002). Here, the at least one PSFCH occasion may be configured per resource pool (RP), and the transmission of the PSFCH may be performed within a channel occupancy time (COT).

Meanwhile, the at least one PSFCH occasion may be allocated to at least one slot. Here, the at least one slot may comprise a plurality of slots, and the transmission of the PSFCH may be performed via one of the plurality of slots.

Furthermore, PSFCH transmission attempts may be sequentially performed for the plurality of slots, and prior to the one slot in which the transmission of the PSFCH is performed, there may exist at least one slot in which a transmission attempt of the PSFCH has failed.

The period of the foregoing at least one PSFCH occasion may be one of 1 slot, 2 slots, and 4 slots.

Channel occupancy sharing information may be received from another terminal, and the transmission of the PSFCH may be performed using it.

Hereinafter, an apparatus to which the present specification may be applied will be described.

FIG. 11 illustrates a wireless communication apparatus according to an embodiment of the present specification.

Referring to FIG. 11, a wireless communication system may include a first apparatus (100) and a second apparatus (200).

The first apparatus (100) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The second apparatus (200) may be a base station, a network node, a transmitting terminal, a receiving terminal, a wireless device, a wireless communication device, a vehicle (e.g., a vehicle equipped with autonomous driving functions, a Connected Car), an Unmanned Aerial Vehicle (UAV), an Artificial Intelligence (AI) module, a robot, an Augmented Reality (AR) device, a Virtual Reality (VR) device, a Mixed Reality (MR) device, a hologram device, a public safety device, an MTC device, an IoT device, a medical device, a fintech device (or financial device), a security device, a climate/environmental device, a device related to 5G services, or a device related to other fields of the Fourth Industrial Revolution.

The first apparatus (100) may include at least one processor such as a control unit (1020), at least one memory such as a memory unit (1030), and at least one transceiver such as a transceiver unit (1010). It may further include a power supply unit (1040) for supplying and controlling power to the control unit (1020), the memory unit (1030), and/or the transceiver unit (1010). The control unit (1020) may perform the functions, procedures, and/or methods described above. The control unit (1020) may execute one or more protocols. For example, the control unit (1020) may execute one or more layers of a wireless interface protocol. The memory unit (1030) is connected to the control unit (1020) and may store various types of information and/or instructions. The transceiver unit (1010) is connected to the control unit (1020) and may be controlled to transmit and receive wireless signals.

The second apparatus (200) may include at least one processor such as a control unit (2020), at least one memory such as a memory unit (2030), and at least one transceiver such as a transceiver unit (2010). It may further include a power supply unit (2040) for supplying and controlling power to the control unit (2020), the memory unit (2030), and/or the transceiver unit (2010). The control unit (2020) may perform the functions, procedures, and/or methods described above. The control unit (2020) may execute one or more protocols. For example, the control unit (2020) may execute one or more layers of a wireless interface protocol. The memory unit (2030) is connected to the control unit (2020) and may store various types of information and/or instructions. The transceiver unit (2010) is connected to the control unit (2020) and may be controlled to transmit and receive wireless signals.

The memory unit (1030) and/or the memory unit (2030) may be connected internally or externally to the control unit (1020) and/or the control unit (2020), respectively, and may also be connected to other control units through various technologies such as wired or wireless connections.

The first apparatus (100) and/or the second apparatus (200) may have one or more antennas. For example, the antenna (1050) and/or the antenna (2050) may be configured to transmit and receive wireless signals.

While preferred embodiments have been exemplarily described above, the disclosure of this specification is not limited to these specific embodiments, and thus may be modified, changed, or improved in various forms within the spirit of this specification and the scope described in the claims.

What is claimed is:

1. A method of a terminal for performing sidelink communication, the method comprising:
configuring at least one physical sidelink feedback channel (PSFCH) occasion; and
performing transmission of a PSFCH based on the configured at least one PSFCH occasion,
wherein the at least one PSFCH occasion is configured per resource pool (RP), and
wherein the transmission of the PSFCH is performed within a channel occupancy time (COT).

2. The method of claim 1, wherein the at least one PSFCH occasion is allocated to at least one slot.

3. The method of claim 2, wherein the at least one slot comprises a plurality of slots, and wherein the transmission of the PSFCH is performed via one of the plurality of slots.

4. The method of claim 3, further comprising:
sequentially performing PSFCH transmission attempts for the plurality of slots.

5. The method of claim 4, wherein prior to the one of the plurality of slots in which the transmission of the PSFCH is performed, at least one slot exists in which a transmission attempt of the PSFCH has failed.

6. The method of claim 1, wherein a period of the at least one PSFCH occasion is one of 1 slot, 2 slots, and 4 slots.

7. The method of claim 1, further comprising:
receiving channel occupancy sharing information from another terminal.

8. A terminal for performing sidelink communication, comprising:
a control unit; and
a memory unit to store instructions and operably and electrically connected with the control unit, wherein the instructions, when executed by the control unit, are configured to perform operations comprising:
configuring at least one physical sidelink feedback channel (PSFCH) occasion, and
performing transmission of a PSFCH based on the configured at least one PSFCH occasion,
wherein the at least one PSFCH occasion is configured per resource pool (RP), and
wherein the transmission of the PSFCH is performed within a channel occupancy time (COT).

9. The terminal of claim 8, wherein the at least one PSFCH occasion is allocated to at least one slot.

10. The terminal of claim 9, wherein the at least one slot comprises a plurality of slots, and wherein the transmission of the PSFCH is performed via one of the plurality of slots.

11. The terminal of claim 10, wherein the operations further comprise:
sequentially performing PSFCH transmission attempts for the plurality of slots.

12. The terminal of claim 11, wherein prior to the one of the plurality of slots in which the transmission of the PSFCH is performed, at least one slot exists in which a transmission attempt of the PSFCH has failed.

13. The terminal of claim 8, wherein a period of the at least one PSFCH occasion is one of 1 slot, 2 slots, and 4 slots.

14. The terminal of claim 8, wherein the operations further comprise:
receiving channel occupancy sharing information from another terminal.
